(19) United States
(12) Patent Application Publication
(10) Pub. No.: US 2006/0278091 A1
(43) Pub. Date: Dec. 14, 2006

(54) Dual coffee maker

(76) Inventor: Gerard A. Rutigliano, Ridgefield, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/399,179

(22) Filed: Apr. 6, 2006

Related U.S. Application Data
(60) Provisional application No. 60/668,923, filed on Apr. 6, 2005.

(51) Int. Cl. A47J 31/00

(52) U.S. Cl. 99/279

(57) ABSTRACT

A dual coffee maker (10) has a base (12), to support two containers (20, 22) side-by-side. A coffee filter section (24) accommodates one of either: the dual basket filter element (26) or a pair of filter baskets (28, 30). The dual basket filter element (26) has two basket sections (32, 34) joined by a bridge (36) for easy handling. Each section (32, 34) can be filled with a distinct beverage substance such as regular or decaffeinated coffee, tea, etc.

### CROSS-REFERENCE TO RELATED APPLICATIONS

This application is related to and claims priority from U.S. Provisional Application 60/668,923 filed on Apr. 6, 2005.

### BACKGROUND OF THE INVENTION

1. Field of the Invention

The present invention relates to coffee makers and, more particularly, to coffee makers suited for brewing coffee from pre-packaged coffee filter packets and having dual brewing stations to individually and selectively brew coffee simultaneously into two separate containers.

2. Description of Related Art

Various known coffee makers exist in which dual coffee brewing stations are side-by-side in order to brew coffee, or another hot beverage, and deliver the coffee into two separate containers. Some designs provide dual container stations that receive a hot beverage from a common brew source, and thus are limited to the single type of beverage.

### OBJECTS AND BRIEF SUMMARY OF THE INVENTION

It is an object of the present invention to provide a dual coffee maker with the ability to brew two separate beverages at the same time. For example, one side of the coffee maker can brew regular coffee and the other can brew decaffeinated coffee. Or, the other side can brew tea or hot cocoa. These and other objects are achieved by the invention described herein.

### BRIEF DESCRIPTION OF THE DRAWINGS

FIG. 1 is a perspective view of a dual coffee maker according to the present invention.

FIG. 2 is a perspective view of coffee filter baskets according to the present invention.

FIG. 3. is an exploded view of the dual coffee maker according to the present invention.

### DETAILED DESCRIPTION OF THE PREFERRED EMBODIMENT OF THE INVENTION

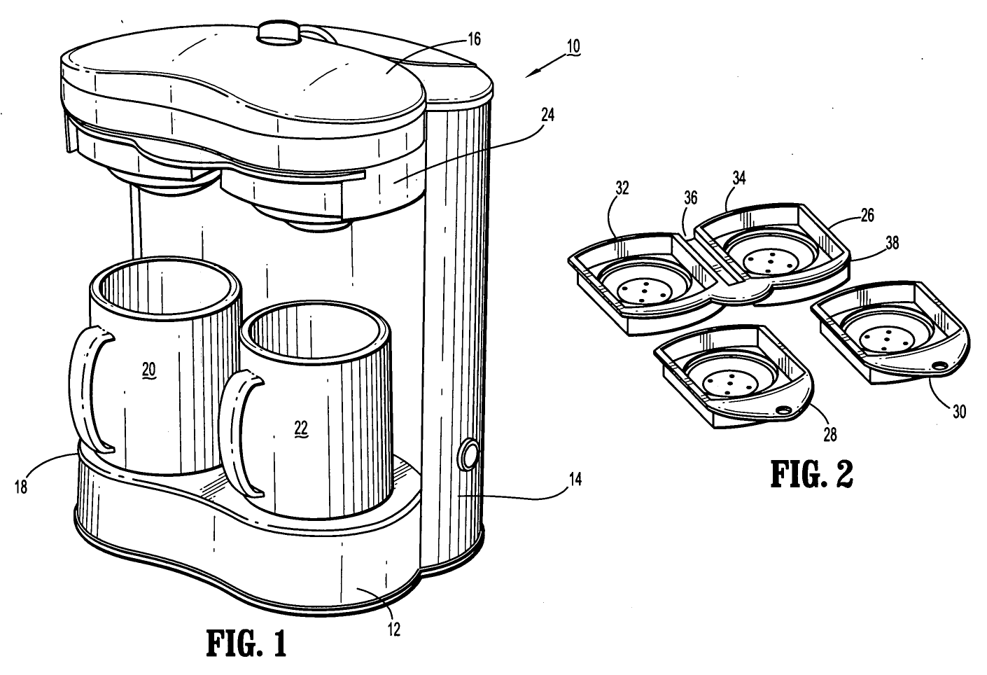

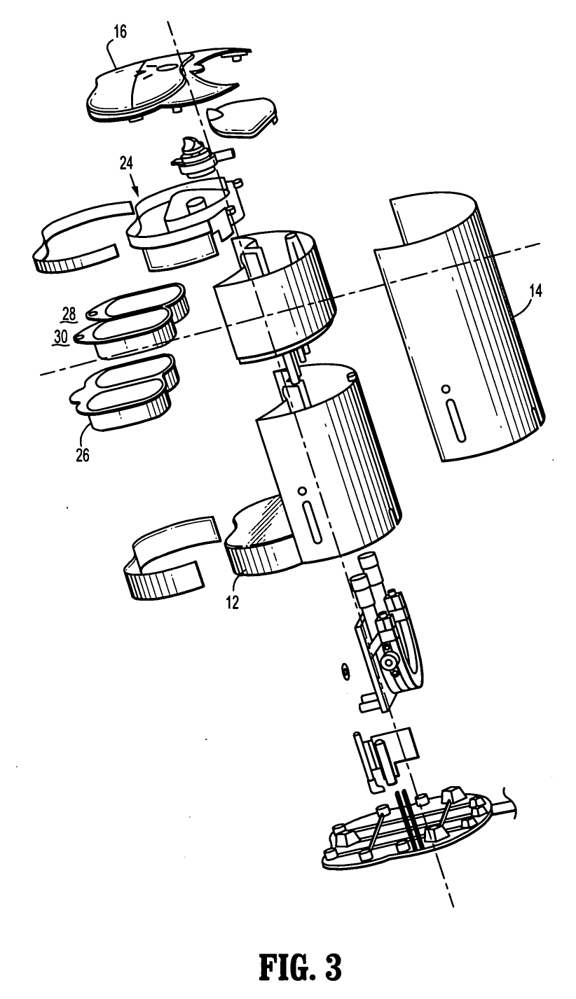

As shown in FIG. 1, a dual coffee maker (10) according to the present invention has a base (12), a housing (14), and a top (16). A container platform (18) may be heatable and is designed to support two containers (20, 22) side-by-side. A coffee filter section (24) accommodates one of either: the dual basket filter element (26) or a pair of filter baskets (28, 30).

The coffee maker (10) is of the type generally known and may be varied without departing from the scope of the novel features presented herein. Those novel features include the dual basket filter element (26), which has two basket sections (32, 34) joined by a bridge (36) for easy handling. Each section (32, 34) can be filled with a distinct beverage substance such as regular or decaffeinated coffee, tea, etc. The element (26) is slid into a slotted portion of a type generally known in single-basket coffee makers, whereby its flange section (38) engages the slot. The pair of baskets (28, 30) may be used instead of the dual basket filter element (26). The baskets (28, 30), as well as the basket sections (32, 34) of the dual basket element (26), each have an opening in the bottom to allow a hot brewed beverage to drip out and into the containers (20,22).

The coffee maker (10) heats water by conventional means and delivers it to a spout, as is known in conventional coffee makers, so that the heated water is delivered into the pair of baskets (28,30) of the dual filter element (26). Pre-packaged coffee filter packets may be used or filters in which the beverage is manually loaded may be used. Also, it is possible to simply deliver heated water into one or both containers (20,22).

Another novel aspect of the invention is a diverter valve, which may be any conventional construction, which is associated with a diverter switch (32) to selectively deliver heated water to one filter side or both filter sides, by being adapted to block water flow to one side.

While the preferred embodiment of the present invention has been herein described, various modification may be made without departing from the scope of the present invention.

What is claimed is:

1) An appliance for brewing a beverage, said appliance comprising
a housing;
a water reservoir for receiving water;
an electric heating element for generating heat and causing said water to be heated;
a conduit through which said water moves away from said reservoir after it is heated;
a spout from which said heated water exits said conduit;
at least one beverage substance container for holding beverage substances near said spout so that water exiting said spout enters said container and mixes with said substances to form a brewed beverage, said container having at least two distinct compartments for holding, respectively, at least two distinct beverage substances therein, each said compartment being separated from the other by at least one wall so that said respective substances do not mix; and
at least one opening in the bottom of each said compartment for enabling said brewed beverage to exit therefrom.

2) An appliance according to claim 1, wherein
said container is removably mounted in said housing.

3) An appliance according to claim 2, wherein
said container is removably mounted in said housing for sliding movement relative thereto to facilitate insertion and removal.

4) An appliance according to claim 1, further comprising
a beverage container support surface for supporting a plurality of beverage containers up to a number of beverage containers corresponding to the number of said compartments.

5) An appliance according to claim 1, further comprising
diverter valve to selectively direct water to exit from said spout into one of said compartments at a time.
